(19) United States
(12) Patent Application Publication
(10) Pub. No.: US 2017/0288606 A1
(43) Pub. Date: Oct. 5, 2017

(54) MEASUREMENT SYSTEM, CONTROL DEVICE, METHOD OF CONTROLLING MEASUREMENT SYSTEM, AND PROGRAM

(71) Applicant: SEIKO EPSON CORPORATION, Tokyo (JP)

(72) Inventor: Kazuyoshi TAKEDA, Chino-shi (JP)

(73) Assignee: SEIKO EPSON CORPORATION, Tokyo (JP)

(21) Appl. No.: 15/451,825

(22) Filed: Mar. 7, 2017

(30) Foreign Application Priority Data
Mar. 29, 2016 (JP) 2016-065221

(51) Int. Cl. H02S 50/00; F16M 11/06; H02S 40/38; F16M 11/04; H02J 7/35; H02S 20/30

(52) U.S. Cl. CPC H02S 50/00; H02J 7/355; H02S 20/30; H02S 40/38; F16M 11/043; F16M 11/06

(57) ABSTRACT

A measurement system includes a solar panel, a support which supports a position of the solar panel in a changeable manner, a battery which stores electric power from the solar panel, a sensor which detects a state of a structure based on electric power from the solar panel, and a processing unit which performs processing based on sensor information from the sensor. The position of the solar panel supported by the support is different in a first predetermined period and a second predetermined period.

### BACKGROUND

### 1. Technical Field

The present invention relates a measurement system, a control device, a method of controlling a measurement system, a program, and the like.

### 2. Related Art

A system using solar power generation is hitherto known. For example, a measurement system (surveillance system or monitoring system) which performs state detection (abnormality detection or monitoring) of a structure using various sensors is known. The structure may be an artificial structure, such as a building, a bridge, or a slope face, or may be a natural structure, such as a natural slope. The state detection of the structure is performed, whereby it is possible to suppress the occurrence of a collapse or a fall of the structure or to suppress enlargement of damage in a case where a collapse or the like occurs.

It is desirable that the state detection of the structure is performed by an independent measurement system. The reason is because, in a case of not a configuration of an independent type, it is necessary to provide a cable for power supply, burden at the time of installation increases, and if disconnection or the like of the cable occurs, a measurement operation cannot be continued. That is, the measurement system has a great benefit with the use of electric power based on sunlight.

JP-A-2007-281058 discloses a power generation method using a solar panel. In JP-A-2007-281058, a power generation system is provided with a rotational drive device and tracks a solar power generation panel toward sunlight.

In the related art method of JP-A-2007-281058 or the like, it is assumed that a solar panel is disposed in an open space where there are no obstacles in the surroundings. For this reason, as in JP-A-2007-281058, it is considered that efficient power generation can be performed by changing the posture (angle) of the solar panel.

However, in a case where a measurement using a sensor is performed, a position where a sensor for a measurement is provided becomes a structure to be observed. In order to implement the configuration of the independent type described above, there is a restriction that the installation position of the solar panel should be close to the installation position of the sensor for a measurement to some extent. For this reason, it should be considered that a solar panel may be installed, for example, in a forest, and there are obstacles obstructing irradiation of the solar panel with sunlight around the solar panel. Under a natural environment, change in the state of obstacles with time, such as leaf fall in winter, is also considered.

In the related art method, the presence or absence of obstacles around the solar panel or changes of the obstacles according to the period are not considered, and there is a problem in that it is difficult to efficiently perform solar power generation in a measurement using a sensor.

### SUMMARY

An advantage of some aspects of the invention is to provide a measurement system, a control device, a method of controlling a measurement system, a program, and the like capable of appropriately generating electric power for driving a sensor and enabling a measurement for a long period.

An aspect of the invention relates to a measurement system including a solar panel, a support which supports a position of the solar panel in a changeable manner, a battery which stores electric power from the solar panel, a sensor which detects a state of a structure based on electric power from the solar panel, and a processing unit which performs processing based on sensor information from the sensor, in which the position of the solar panel supported by the support is different in a first predetermined period and a second predetermined period different from the first predetermined period.

In the aspect of the invention, in the measurement system which operates the sensor based on electric power from the solar panel, the position of the solar panel is different according to the period. Under a condition that state detection of the structure based on a sensor measurement is performed, it is not always true that the solar panel can be installed at an open position, and the state of a surrounding environment may also change according to the period. According to the aspect of the invention, since the position of the solar panel is different according to the period, it is possible to perform efficient solar power generation according to the surrounding environment.

In the aspect of the invention, in the first predetermined period, the processing unit may set the position of the solar panel to a first position, and in the second predetermined period, the processing unit may set the position of the solar panel to a second position different from the first position.

With this configuration, the position according to the period is set, whereby it is possible to perform appropriate position control of the solar panel.

In the aspect of the invention, the position of the solar panel may be a position set based on obstacle information around the solar panel.

With this configuration, it is possible to set the solar panel at an appropriate position according to the state of the obstacles around the solar panel.

In the aspect of the invention, the obstacle information may be information representing a state of trees around the solar panel.

With this configuration, it is possible to set the solar panel at an appropriate position according to the state of the trees around the solar panel.

In the aspect of the invention, the processing unit may control the position of the solar panel based on information relating to the position of the solar panel set based on the obstacle information or information relating to the position of the solar panel determined based on the obstacle information.

With this configuration, it is possible to control the position of the solar panel based on various kinds of information relating to the position of the solar panel.

In the aspect of the invention, the measurement system may further include a storage unit which stores positional information as information capable of uniquely determining the position of the solar panel, and the processing unit may control the position of the solar panel based on the positional information from the storage unit.

With this configuration, it is possible to store the positional information in the measurement system.

In the aspect of the invention, the measurement system may further include a communication unit which receives positional information as information capable of uniquely determining the position of the solar panel from an external apparatus, and the processing unit may control the position of the solar panel based on the positional information received by the communication unit.

With this configuration, it is possible to receive the positional information from the external apparatus.

In the aspect of the invention, the support may support at least one of a position in a vertical direction or a position in a horizontal direction of the solar panel in a changeable manner.

With this configuration, it is possible to make at least one of the position in the vertical direction or the position in the horizontal direction of the solar panel different according to the period.

In the aspect of the invention, the support may include an arm to which the solar panel is fixed, and the processing unit may drive the arm to change at least one of the position in the vertical direction or the position in the horizontal direction of the solar panel.

With this configuration, it is possible to control the position of the solar panel using the arm.

In the aspect of the invention, the support may include a guide shaft in which a direction along the vertical direction is a longitudinal direction, and the arm may be configured to perform at least one of movement in the longitudinal direction of the guide shaft or rotation around the guide shaft.

With this configuration, it is possible to control the position of the solar panel using the arm movable with respect to the guide shaft.

In the aspect of the invention, the measurement system may further include a power supply unit which supplies electric power based on natural energy different from sunlight, and the processing unit may control the position of the solar panel based on electric power from the power supply unit.

With this configuration, it is possible to use natural energy other than sunlight for the position control of the solar panel.

In the aspect of the invention, the measurement system may further include a plurality of solar panels as the solar panel, and the processing unit may control the position of each solar panel of the plurality of solar panels.

With this configuration, it is possible to perform efficient power generation using a plurality of solar panels.

In the aspect of the invention, the first predetermined period and the second predetermined period may be specific periods of a year.

With this configuration, it is possible to make the position of the solar panel different in a given period and another period of a year per year.

In the aspect of the invention, the processing unit may control the position of the solar panel based on weather information around the solar panel.

With this configuration, it is possible to use the weather information for the position control of the solar panel.

In the aspect of the invention, the support may support a posture of the solar panel in a changeable manner, and the processing unit may control the position and the posture of the solar panel.

With this configuration, it is possible to control not only the position of the solar panel but also the posture of the solar panel.

Another aspect of the invention relates to a control device including an information acquisition unit which acquires sensor information from a sensor detecting a state of a structure based on electric power from a solar panel, and a processing unit which performs processing based on the sensor information and control of a position of the solar panel, in which in the first predetermined period, the processing unit sets the position of the solar panel to a first position, and in a second predetermined period different from the first predetermined period, the processing unit sets the position of the solar panel to a second position different from the first position.

In the aspect of the invention, in the control device which performs acquisition of the sensor information from the sensor detecting the state of the structure based on electric power from the solar panel and processing based on the sensor information, the position of the solar panel is changed according to the period. Under a condition that a sensor measurement is performed, it is not always true that the solar panel can be installed at an open position, and the state of the surrounding environment may also change according to the period. According to the aspect of the invention, since it is possible to change the position of the solar panel according to the period, it is possible to perform efficient solar power generation according to the surrounding environment, and to appropriately acquire the sensor information.

Another aspect of the invention relates to a method of controlling a measurement system having a solar panel capable of changing a position and a sensor detecting a state of a structure based on electric power from the solar panel, including, in a first predetermined period, setting the position of the solar panel to a first position, and in a second predetermined period different from the first predetermined period, setting the position of the solar panel to a second position different from the first position.

Another aspect of the invention relates to a program causing a computer to execute information acquisition processing for acquiring sensor information of a sensor detecting a state of a structure based on electric power from a solar panel, processing based on the sensor information, and position control of the solar panel. As the position control, in a first predetermined period, the position of the solar panel is set to a first position, and in a second predetermined period different from the first predetermined period, the position of the solar panel is set to a second position different from the first position.

### BRIEF DESCRIPTION OF THE DRAWINGS

The invention will be described with reference to the accompanying drawings, wherein like numbers reference like elements.

FIG. 1 shows a configuration example of a measurement system.

FIG. 2 shows an appearance example of the measurement system.

FIG. 3 shows a specific configuration example of a guide shaft.

FIG. 4 shows an appearance example of the measurement system.

FIG. 5 shows an example of an installation environment of the measurement system.

FIG. 6 is an explanatory view of processing for calculating positional information.

FIG. 7 is an explanatory view of the processing for calculating the positional information.

FIG. 8 is a flowchart illustrating position control of a solar panel.

FIG. 9 shows a connection example of the measurement system and an external apparatus.

FIG. 10 shows a configuration example of a control device.

FIG. 11 shows a configuration example of a system including the control device.

### DESCRIPTION OF EXEMPLARY EMBODIMENTS

Hereinafter, an exemplary embodiment of the invention will be described in detail. It should be noted that this embodiment described hereinafter is not intended to limit the content of the invention as described in the appended claims in any way, and all of the configurations described in this embodiment may not be essential constituent elements in the invention.

### 1. Method of this Embodiment

First, a method of this embodiment will be described. As described above, in a measurement system which performs state detection of a structure using a sensor, it is desirable to use an independent device. If the measurement system is an independent type, work or the like for installing a cable is not required, and it is not necessary to consider an abnormality of the cable. In a situation in which an abnormality occurs in the structure, there is a possibility that an abnormality, such as disconnection, also occurs in the cable, and there is a concern that electric power is not supplied in a situation in which a measurement is required or measured information cannot be output to the outside. If the measurement system is an independent type, such a possibility may not be considered.

In a case where a cable for power supply is not provided, a battery needs to be incorporated in a device for a measurement. In a case where a battery which needs to be frequently replaced or charged by a user is used as the battery, it is not preferable that maintenance burden on the user is large. Hence, a device which does not need power supply through a cable or does not need to be charged by the user may be used, and the use of natural energy is considered. In the state detection of the structure, since an unpredictable abnormality of the structure should be able to be detected, constant monitoring is important, and from this viewpoint, charging with natural energy has a great benefit.

In solar power generation using a solar panel, in order to perform appropriate power generation, the solar panel needs to be irradiated with a sufficient amount of sunlight. For this reason, JP-A-2007-281058 discloses a method which controls the posture (angle) of the solar panel according to the orbit of the sun.

However, in JP-A-2007-281058, it is supposed that the solar panel is necessarily irradiated with sunlight if the posture of the solar panel is changed. In other words, it is supposed that there are no obstacles shielding sunlight to the solar panel around the solar panel.

If the degree of freedom of the installation position of the solar panel becomes large, a position where there are few obstacles may be selected as the installation position of the solar panel. However, in the measurement system using the sensor, the degree of freedom of the installation position of the solar panel is not large. The reason is because a target to be observed (monitored) by the sensor is determined and the sensor needs to be installed at a position where the target is appropriately measurable. For example, in a case of performing fall detection of an artificial slope or a slope face, a sensor, such as a vibration sensor, is buried in the slope. While the installation position of the solar panel does not need to strictly match the installation position of the sensor, since it is not appropriate to use an excessively long cable as described above, the solar panel is installed at a position close to the sensor to some extent.

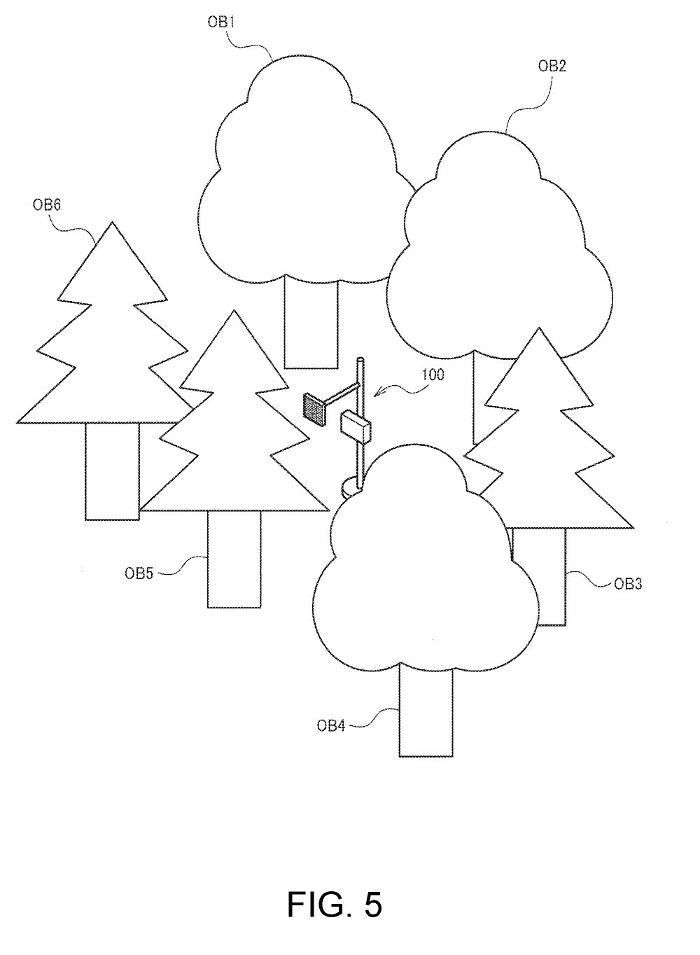

For this reason, for example, as described below referring to FIG. 5, a situation may occur in which there are many obstacles around the solar panel. In this case, if there is an obstacle between the sun and the solar panel, sunlight is shielded by the obstacle. For this reason, even if the posture of the solar panel is changed, efficient power generation is difficult. That is, in the method of JP-A-2007-281058, efficient power generation cannot be performed.

In particular, in a case where an obstacle is a tree (in particular, a deciduous tree) as in FIG. 5, since the leaves grow thickly in summer, there are comparatively many obstacles; however, since the leaves fall from the trees in winter, there are comparatively little obstacles. That is, while it is desirable to change power generation control with change in the state of the obstacles according to the period, JP-A-2007-281058 or the like does not disclose such a method.

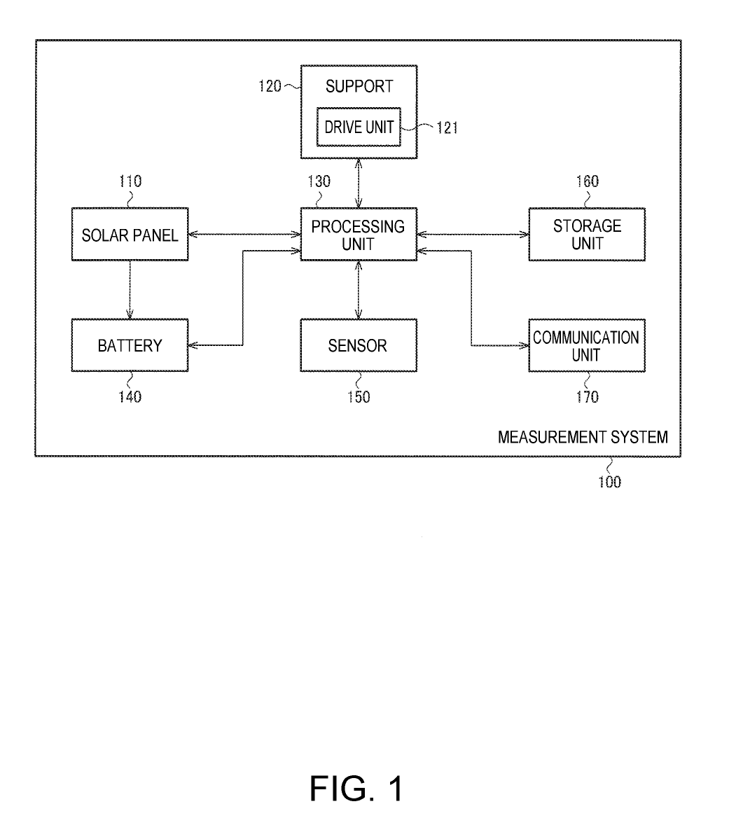

As shown in FIG. 1, a measurement system 100 according to this embodiment includes a solar panel 110, a support 120 which supports the position of the solar panel 110 in a changeable manner, a battery 140 which stores electric power from the solar panel 110, a sensor 150 which detects a state of a structure based on electric power from the solar panel 110, and a processing unit 130 which performs processing based on sensor information from the sensor 150. The position of the solar panel 110 supported by the support 120 is different in a first predetermined period and a second predetermined period different from the first predetermined period.

Electric power from the solar panel 110 may be electric power which is supplied directly from the solar panel 110 or may be electric power which is stored in the battery 140 and supplied from the battery 140.

In a method of this embodiment, the position of the solar panel 110 is changeable. The position may be a position in a vertical direction (gravity direction), a position in a horizontal direction, or both of the position in the vertical direction and the position in the horizontal direction. For this reason, in a case where the solar panel 110 is at a given position, even if sunlight is shielded by an obstacle, the solar panel 110 is moved to a different position, whereby it is possible to perform appropriate power generation while avoiding the obstacle. In the method of this embodiment, the position of the solar panel 110 is changeable according to a period. For this reason, even if the state of the obstacle is changed according to the period (in a narrow sense, season), it is possible to set the solar panel 110 at an appropriate position according to the change.

Hereinafter, a configuration example of the measurement system 100 of this embodiment will be described, and then, a specific example of a method of controlling the position of the solar panel 110 will be described. Finally, some modification examples will be described.

### 2. System Configuration Example

A configuration example of the measurement system 100 according to this embodiment is as shown in FIG. 1, and the measurement system 100 includes the solar panel 110, the support 120, the processing unit 130, the battery 140, the sensor 150, a storage unit 160, and a communication unit 170. The measurement system 100 is not limited to the configuration of FIG. 1, and may be modified in various ways such that a part of the constituent elements may be omitted or other constituent element may be added, or the like.

The solar panel 110 is a panel which generates electric power based on irradiation of sunlight, and is constituted of an arrangement of a plurality of solar battery elements (cells). For the solar panel 110 according to this embodiment, panels having various known structures are applicable, and thus, detailed description thereof will not be repeated. Though not shown in FIG. 1, the measurement system 100 may include various circuits which supply electric power from the solar panel 110 to the battery 140.

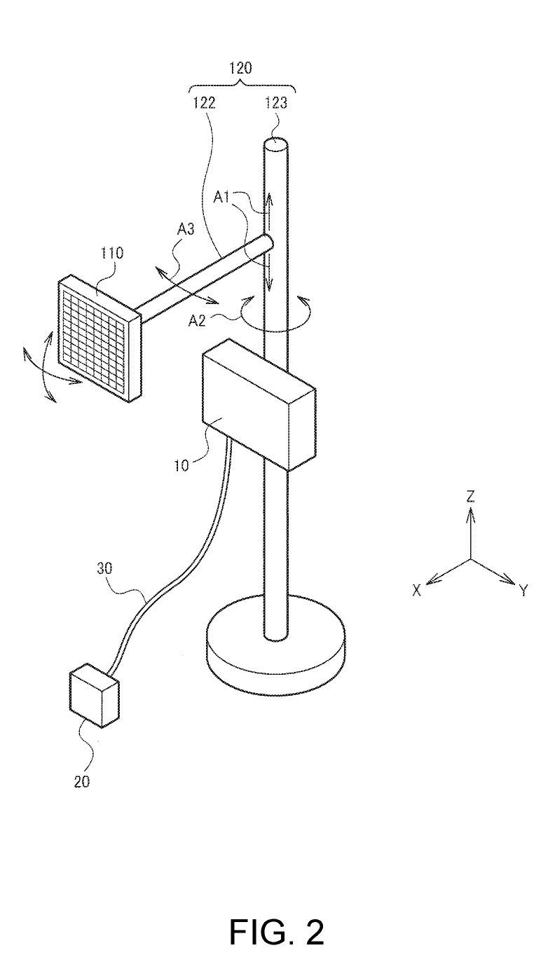

The support 120 supports the position of the solar panel 110 in a changeable manner (in a freely changing manner). The support 120 includes a drive unit 121, and the drive unit 121 is driven based on a control signal from the processing unit 130, whereby the support 120 changes the position of the solar panel 110. The drive unit 121 can be implemented with actuators having various configurations, such as a stepping motor or a voice coil motor (VCM). A specific example of the support 120 will be described below referring to FIGS. 2 to 4.

The processing unit 130 performs various kinds of processing based on sensor information from the sensor 150 or information received by the communication unit 170. The function of the processing unit 130 can be implemented with various processors, such as a central processing unit (CPU), hardware, such as an application specific integrated circuit (ASIC) and a gate array, a program, and the like.

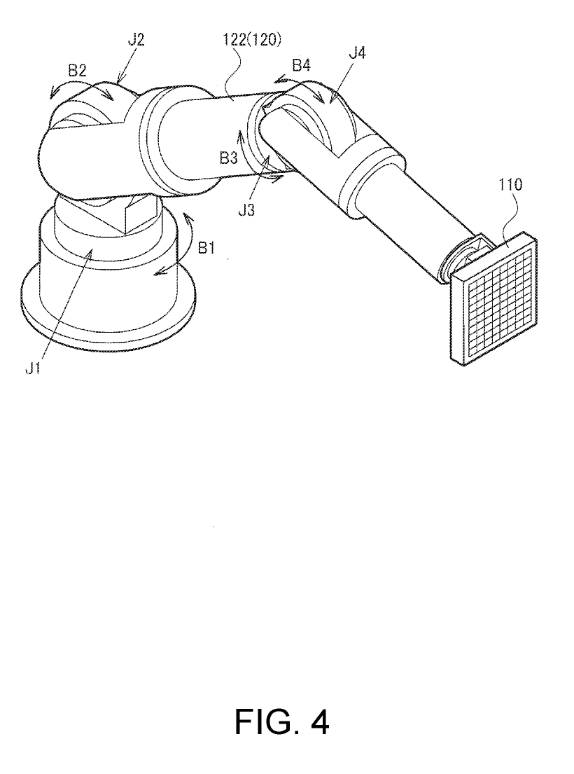

The processing unit 130 controls the position of the solar panel 110 based on positional information. The positional information is information capable of uniquely determining the position of the solar panel 110. For example, in a case of using a space specified by three axes of XYZ, (x,y,z) which is a combination of coordinate values on the respective axes may be used as the positional information. Alternatively, in a case where rotation angles around the respective axes are (u,v,w), (x,y,z,u,v,w) representing both of the position and the posture may be used as the positional information. Alternatively, specific control information for determining the position of the solar panel 110 to be (x,y,z) in the measurement system 100 may be used as the positional information. For example, in an example described below referring to FIG. 4, a set of joint angles (θ1,θ2,θ3,θ4) of four joints may be used as the positional information. The positional information may be generated in the processing unit 130 or may be acquired from other apparatuses.

The battery 140 stores electric power generated in the solar panel 110. The battery 140 according to this embodiment can be implemented with various well-known secondary batteries, such as a lithium-ion battery or a lead storage battery. Though not shown in FIG. 1, electric power is supplied from the battery 140 to portions other than the solar panel 110 of the measurement system 100. To the processing unit 130, electric power may be supplied from the solar panel 110 without electric power supply from the battery 140 or electric power may be supplied from the battery 140, and various modifications can be made.

The sensor 150 includes at least a sensor for state detection of the structure. As the sensor for state detection, an inclination sensor, a vibration sensor, or the like is considered.

The inclination sensor detects the inclination of the structure in which the sensor is installed. The vibration sensor detects vibration of the structure. The inclination sensor and the vibration sensor can be implemented with, for example, acceleration sensors. Since an acceleration sensor detects a gravitational acceleration, an inclination is detected by detecting change in gravitational acceleration from an acceleration signal. In a case where vibration appears as fluctuation in acceleration, vibration intensity is detected from the magnitude of the acceleration, and a vibration frequency is detected from the frequency characteristics (for example, a result of fast Fourier transform (FFT)) of the acceleration. A detection method of the inclination or vibration is well known, and thus, further detailed description thereof will not be repeated.

To the measurement system 100, various sensors, such as a water level sensor, an imaging sensor (camera), and a weather sensor (weather meter), can be added.

The storage unit 160 becomes a work area of the processing unit 130 or the like, and the function thereof can be implemented with a memory, such as a random access memory (RAM), a hard disk drive (HDD), or the like. The storage unit 160 stores the positional information for determining the position of the solar panel 110.

The communication unit 170 performs communication of information with other apparatuses through a network. The network can be implemented with a wide area network (WAN), a local area network (LAN), or the like, regardless of whether wired manner wireless. The network may be implemented with near field communication.

FIG. 2 is an example of an appearance diagram of the measurement system 100 (measurement device and sensor terminal) according to this embodiment. The measurement system 100 includes a housing 10, a sensor housing 20, the solar panel 110, and the support 120.

The housing 10 is a housing which houses a substrate with the processing unit 130 provided thereon and the battery 140. The sensor housing 20 is a housing which is connected to the housing 10 by a cable 30, and houses the sensor 150. In FIG. 2, although an example where one sensor housing 20 is provided is shown, a plurality of sensor housings 20 may be provided. For example, a case where the measurement system 100 includes, as the sensor 150, an inclination sensor, a vibration sensor, a water level sensor, and an imaging sensor is considered. The inclination sensor or the vibration sensor is provided on the surface of the structure, the water level sensor is provided at a position where at least a part thereof is dipped into a liquid to be observed, and the imaging sensor is provided at a position and angle at which a desired area of the structure can be imaged. That is, since a desirable installation position is different according to the sensor type, various modifications can be made to the number of sensor housings 20, the shape of the sensor housing 20, the installation position, and the installation method. Alternatively, a part of the sensor 150 may be housed in the housing 10.

As shown in FIG. 2, the support 120 may include arm 122 to which the solar panel 110 is fixed. In this case, the processing unit 130 drives the arm 122 to change at least one of the position in the vertical direction or the position in the horizontal direction of the solar panel 110. In the example of FIG. 2, the support 120 includes a guide shaft 123 in which a direction along the vertical direction is a longitudinal direction, and the arm 122 is configured to perform at least one of movement (A1) in the longitudinal direction of the guide shaft 123 or rotation (A3) around the guide shaft 123. With this, it is possible to control the position of the solar panel 110 using the arm 122.

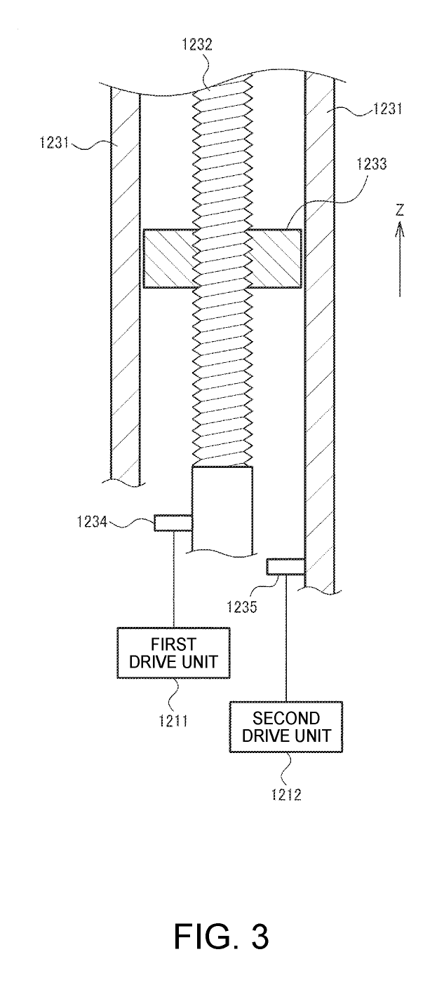

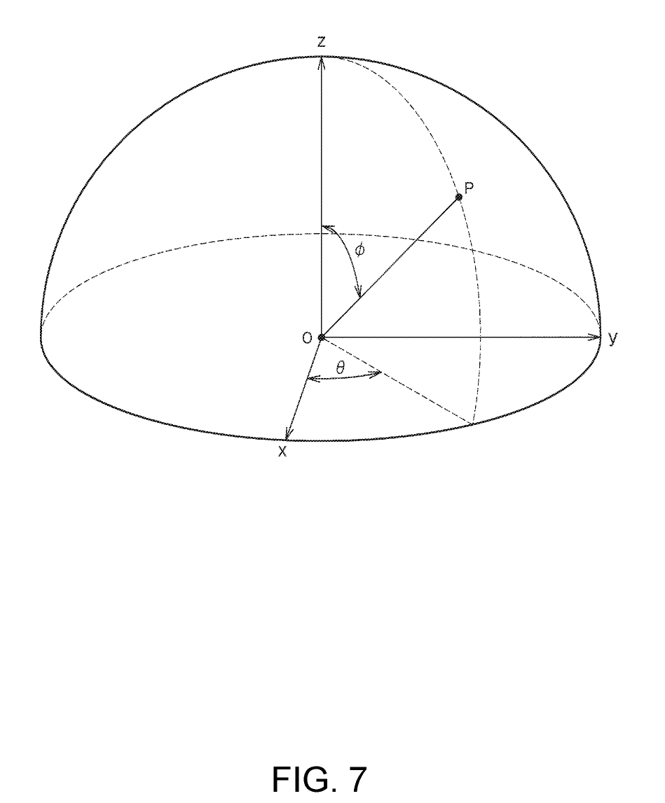

In FIG. 2 (and FIGS. 3 and 7 described below), the axis along the vertical direction is referred to as a Z axis, and the axes orthogonal to the Z axis are referred to as an X axis and a Y axis. In a narrow sense, the Z-axis negative direction becomes a gravity direction, and the XY plane becomes a plane orthogonal to the gravity direction, that is, a horizontal plane. In a case where the device shown in FIG. 2 is installed with no inclination, the longitudinal direction of the guide shaft 123 becomes the Z-axis direction, and the rotation around the guide shaft 123 becomes rotation in the XY plane.

FIG. 3 shows an example of a basic configuration for implementing the movement of the arm 122 in the longitudinal direction of the guide shaft 123 and the rotation of the arm 122 around the guide shaft 123, and is a diagram showing a cross-section of the guide shaft 123. First, the movement of the arm 122 in the longitudinal direction of the guide shaft 123 can be implemented with a rotation-linear conversion mechanism, such as a ball screw. For example, the guide shaft 123 of the support 120 includes a linear guide (guide rail) 1231, a screw shaft 1232, and a nut 1233. The nut 1233 is configured so as to be slidable in the Z-axis direction along the linear guide 1231 while relative rotation thereof with respect to the linear guide 1231 is regulated by the linear guide 1231. The linear guide 1231 corresponds to, for example, a surface member of the guide shaft 123 in FIG. 2. Though not shown in FIG. 3, a ball may be provided between the screw shaft 1232 and the nut 1233.

The guide shaft 123 includes a gear 1234 which meshes with the screw shaft 1232, and a first drive unit 1211 which is the drive unit 121 rotating the gear 1234. The first drive unit 1211 rotates the gear 1234, whereby the screw shaft 1232 rotates. With the rotation of the screw shaft 1232, the nut 1233 is guided to the linear guide 1231 and slides in a direction (the longitudinal direction of the guide shaft 123) along the Z axis. The arm 122 is coupled to the nut 1233, whereby it is possible to move the arm 122 in a direction along the longitudinal direction of the guide shaft 123 as indicated by A1 of FIG. 2. Specifically, the processing unit 130 performs control for driving the first drive unit 1211 to move the arm 122 in the direction along the longitudinal direction of the guide shaft 123.

The guide shaft 123 includes a gear 1235 which meshes with the linear guide 1231, and a second drive unit 1212 which is the drive unit 121 rotating the gear 1235. The second drive unit 1212 rotates the gear 1235, whereby the linear guide 1231 rotates in a direction indicated by A2 of FIG. 2. The linear guide 1231 itself rotates around the Z axis (the longitudinal direction of the guide shaft 123), whereby the nut 1233 rotates around the Z axis even if relative rotation with respect to the linear guide 1231 is regulated. With this, it is possible to rotate the arm 122 coupled to the nut 1233 around the Z axis as indicated by A3 of FIG. 2. Specifically, the processing unit 130 performs control for driving the second drive unit 1212 to rotate the arm 122 around the longitudinal direction of the guide shaft 123.

In this way, the support 120 supports at least one of the position in the vertical direction or the position in the horizontal direction of the solar panel 110 in a changeable manner. In the example of FIGS. 2 and 3, while both of the position in the vertical direction and the position in the horizontal direction are changeable with the movement of A1 and A3, one of A1 and A3 may be omitted.

In a case of the configuration of FIGS. 2 and 3, the tip position of the arm 122 where the solar panel 110 is provided is determined is movable on a columnar side surface whose height is determined by a movable range of the nut 1233 in the Z-axis direction and radius is determined by the length (in a narrow sense, the length between a connection portion to the guide shaft 123 and a fixed position of the solar panel 110) of the arm 122. Hence, the processing unit 130 performs control for setting any one position in an area on the columnar side surface as the position of the solar panel 110.

As indicated by A4 of FIG. 2, the support 120 may support the posture of the solar panel 110 in a changeable manner. For example, an end effector, such as an adsorption hand, may be provided at the tip of the arm 122, and change of the posture of the solar panel 110 indicated by A4 may be performed by the end effector. Alternatively, instead of a hand, a frame which suppresses detachment of the solar panel 110 may be provided in the arm 122. In any case, a member capable of changing the posture with respect to the arm 122 is provided and the solar panel 110 is fixed to the member, whereby it is possible to change the posture of the solar panel 110.

In this case, the processing unit 130 controls the position and the posture of the solar panel 110. With this, since it is possible to control the posture of the solar panel 110 in addition to the position of the solar panel 110, it is possible to perform more efficient power generation.

The configuration of the measurement system 100, in particular, the configuration of the support 120 is not limited to FIGS. 2 and 3, and various modifications can be made. For example, the support 120 and the solar panel 110 of the measurement system 100 may have a configuration shown in FIG. 4. In an example of FIG. 4, the support 120 includes an arm 122, and the arm 122 includes joints J1 to J4, and a frame connecting the joints. In the example of FIG. 4, the joints J1 to J4 are respectively rotatable in directions of B1 to B4. If the rotation angles of the respective joints are referred to as θ1 to θ4, the tip position of the arm 122, that is, the position of the solar panel 110 can be calculated by forward kinematics based on θ1 to θ4 and a frame length. Conversely, if a desired position of the solar panel 110 is calculated, the joint angles θ1 to θ4 for implementing the position can be obtained from inverse kinematics.

In the example of FIG. 4, since the arm 122 having a higher degree of freedom is used, it is possible to flexibly set the position of the solar panel 110 compared to the example of FIG. 2. For this reason, even in a case where there are many obstacles and an area where sunlight can be appropriately received is narrow, it is possible to set the solar panel 110 at an appropriate position. Even in the example of FIG. 4, a joint is provided at the tip of the arm 122, thereby changing the posture of the solar panel 110.

While the higher the degree of freedom of the arm 122, the higher the degree of freedom of the position of the solar panel 110, electric power required for the control of the arm 122 increases. For example, the number of joints increases, large electric power is required for the drive of the arm 122 (the drive of the drive unit 121) compared to a simple configuration. Furthermore, since a load of calculation processing of the drive amount of the drive unit 121 for implementing a desired position increases, there is a possibility that power consumption in the processing unit 130 increases.

In this embodiment, it is assumed that the arm 122 is driven based on electric power from the solar panel 110. For this reason, there is a case where reduction in power consumption with the drive of the arm 122 is more important that flexible drive of the arm 122. Hence, a specific structure of the support 120 may be determined in consideration of electric power required for control and the degree of increase of power generation efficiency with adjustment of the position of the solar panel 110.

For example, the support 120 of this embodiment may have a mechanism which performs movement on only one axis of the solar panel 110. For example, a configuration is considered in which the support 120 has a rail on a straight line and a belt and the drive unit 121 drives the belt to linearly move a stand, to which the solar panel 110 is fixed, along the rail. If such a simple configuration is made, a load of calculation processing of an optimum position of the solar panel 110 is low, and control in the drive unit 121 is easily performed. Furthermore, the lengths of the rail and belt are extended, whereby it is possible to easily enlarge the movable range of the solar panel 110. In addition, as described below as a modification example, in a case where the measurement system 100 has a plurality of solar panels 110, rails for the respective solar panels 110 are arranged in a row (in a narrow sense, in parallel), whereby it is possible to cover a wide area.

As in a modification described below, the position control of the solar panel 110 may be performed using electric power from a power supply unit different from the solar panel 110. In this case, since the use of electric power for the drive the support 120 is hardly disadvantageous, it is possible to use the support 120 having a more complicated configuration.

### 3. Specific Example of Position Control

Next, a specific example of a method of controlling the position of the solar panel 110 will be described. FIG. 5 shows a surrounding environment example in a measurement state of the measurement system 100 according to this embodiment. In the example of FIG. 5, there are trees OB1 to OB6 around the measurement system 100, and these become obstacles shielding sunlight. It is known that there are deciduous trees and evergreen trees as the trees. In regards to the deciduous trees, while the degree of shielding sunlight is small since the leaves fall from the trees in winter, the degree of shielding sunlight is large since the leaves grow thickly in a period centering on summer. That is, in a case where there are deciduous trees around the measurement system 100, the state of obstacles changes according to the season.

In this embodiment, the position of the solar panel 110 becomes a position set based on obstacle information around the solar panel 110. With this, it is possible to set the solar panel 110 at a position where there is less influence of the obstacles, specifically, at a position where sunlight incident on the solar panel 110 is not shielded by the obstacles, and it is possible to perform efficient solar power generation.

Specifically, the obstacles may be trees as shown in FIG. 5. That is, the obstacle information may be information representing the state of trees around the solar panel 110. With this, it is possible to suppress the influence of the trees, and to perform appropriate solar power generation.

As described above, the processing unit 130 performs control for setting the position of the solar panel 110 to different positions in the first predetermined period and the second predetermined period. The first predetermined period and the second predetermined period in this embodiment may be specific periods of a year in a narrow sense. More specifically, the first predetermined period may be summer (summer period) and the second predetermined period may be winter (winter period).

With this, it is possible to appropriately change the position of the solar panel 110 with change in the state of the obstacles according to the season. According to the above-described example, it is possible to control the position of the solar panel 110 according to the growing state of the leaves of the deciduous trees.

In the control for setting the position of the solar panel 110 to different positions in the first predetermined period and the second predetermined period, the processing unit 130 sets the position of the solar panel 110 to a first position in the first predetermined period, and sets the position of the solar panel 110 to a second position different from the first position in the second predetermined period. That is, with the use of the position for the first predetermined period and the position for the second predetermined period, the position of the solar panel 110 according to the period is implemented. With this, in each period, the position according to the period is used, whereby it is possible to implement the position control of the solar panel 110.

However, in the first predetermined period, the solar panel 110 does not need to be constantly fixed at one position. In other words, in the first predetermined period, the processing unit 130 may change the position of the solar panel 110. As an example, one position may be set per week, and the position of the solar panel 110 may be changed once per week. Similarly, the position of the solar panel 110 may be changed in the second predetermined period.

In this case, the first position does not represent one position, and is a set (area) of a plurality of positions which can be employed in the first predetermined period, and the second position is a set (area) of a plurality of positions which can be employed in the second predetermined period. At this time, the first position and the second position may not completely match each other, and partial areas may overlap each other. Of course, there may be no area where the first position and the second position overlap each other.

Next, a specific method of determining the position of the solar panel 110 based on the obstacle information will be described. The obstacle information may be image information obtained, for example, by imaging the surroundings of the measurement system 100 with a wide angle camera (an omnidirectional camera or a camera having a fish-eye lens). Alternatively, image information in which a plurality of images acquired using a camera having a general lens are combined or image information acquired by panoramic imaging may be used as the obstacle information.

The measurement system 100 may include an imaging sensor as the sensor 150, and may acquire the obstacle information based on the imaging sensor. Alternatively, the obstacle information may be acquired from an external apparatus. For example, the user may perform imaging using a camera at the time of the installation of the measurement system 100, or the like, and image information as imaging information may be used as the obstacle information.

It is desirable that the obstacle information is not image information but information representing an image processing result on the image information. Specifically, processing for detecting an obstacle may be performed, and information for identifying an area where an obstacle is imaged from other areas may be set as the obstacle information. In the detection of the obstacles, color determination processing using the color (green or brown) of the trees and the color (blue) of the sky may be performed or edge detection processing may be performed, and various well-known image processing can be applied.

In this embodiment, the processing unit 130 controls the position of the solar panel 110 based on information relating to the position of the solar panel 110 determined based on the obstacle information. Information relating to the position of the solar panel 110 may be positional information which is information capable of uniquely specifying the position of the solar panel 110 or other kinds of information representing the position of the solar panel 110. That is, in this embodiment, the positional information may be calculated based on the obstacle information in the processing unit 130. With this, since it is possible to calculate the positional information in the measurement system 100, it is possible to perform the position control of the solar panel 110 as control which is completed inside the measurement system 100.

In this case, as shown in FIG. 1, the measurement system 100 includes the storage unit 160 which stores the positional information (information capable of uniquely determining the position of the solar panel 110) for setting the position of the solar panel 110, and the processing unit 130 controls the position of the solar panel 110 based on the positional information from the storage unit 160. With this, it is possible to store (hold) the positional information in the storage unit 160 of the measurement system 100.

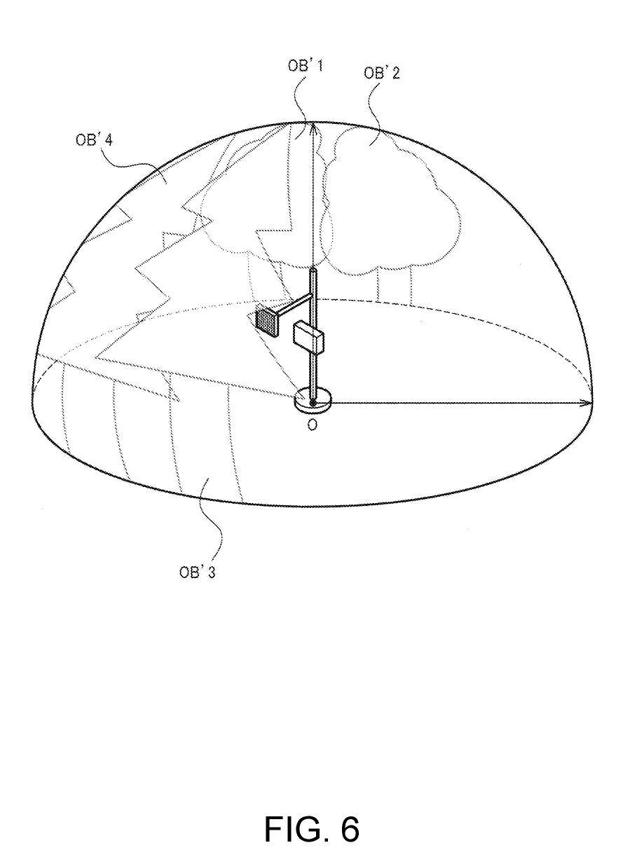

FIGS. 6 and 7 are diagrams illustrating a method of calculating the positional information based on the obstacle information. The relative position of the sun with respect to the measurement system 100 can be implemented with a celestial sphere with the position of the measurement system 100 as the origin O as in FIG. 6, and the sun moves positions on the surface of the celestial sphere. The orbit of the sun is expressed using an azimuth. For example, the orbit of the sun is expressed by a NED coordinate system with north, east, and down as the positive directions of the respective axes. For this reason, coordinate conversion processing between the coordinate system (XYZ axes) used in the measurement system 100 and the NED coordinate system may be performed. The coordinate conversion is known, and thus, detailed description thereof will not be repeated. Hereinafter, description will be provided assuming that the orbit of the sun is converted to the coordinate system using the three axes of XYZ.

Since the orbit of the sun can be expressed on the celestial sphere, if the respective obstacles around the measurement system 100 can be arranged on the celestial sphere, in the processing unit 130, it is possible to obtain information regarding whether or not the respective obstacles obstructs the incidence of sunlight, a period during which the respective obstacles obstruct the incidence of sunlight if so, or the like. Hence, the processing unit 130 performs processing for arranging the surrounding obstacles on the celestial sphere based on the acquired obstacle information. Specifically, processing for correlating the positions on the image with the positions on the celestial sphere may be performed. For example, a reference point is set on the image, and a position of s pixels in a right direction and t pixels in a downward direction from the reference point is expressed as (s,t). The ranges of s and t change according to the resolution of the image or the position of the reference point. The position on the celestial sphere can be expressed as (θ,φ) using an angle θ with respect to the x axis and an angle φ with respect to the z axis as shown in FIG. 7. Since the degree of distortion in the image is known from design of the lens, g₁ and g₂ satisfying Expressions (1) and (2) described below can be calculated in advance.

θ=g₁(s,t) (1)

φ=g₂(s,t) (2)

The processing unit 130 projects the obstacles onto the celestial sphere based on the obstacle information and Expressions (1) and (2) described above and determines obstacle areas which are areas covered with the obstacles in the celestial sphere. In the example of FIG. 6, the obstacles are projected onto the celestial sphere based on the obstacle information and OB′1 to OB′4 are set as the obstacle areas. In the orbit of the sun, an irradiatable area which does not overlap the obstacles areas is determined. In the irradiatable area, sunlight is not shielded by the obstacles and can reach the measurement system 100. In the measurement system 100, in a time zone when the sun is at a position corresponding to the irradiatable area, power generation may be performed using the solar panel 110. That is, the processing unit 130 performs control for moving the solar panel 110 to such a position to be directed to the irradiatable area.

A specific example is shown in FIG. 7. In FIG. 7, a point P is a representative point included in the irradiatable area. As the point P, for example, the center position of the irradiatable area may be used. Alternatively, from the viewpoint of efficiently performing power generation when the sun is at a high position, the point P may be a point with a maximum elevation angle (in FIG. 7, 90°−φ) in the irradiatable area. In addition, a method of obtaining the point P from the irradiatable area may be modified in various ways.

In the example of FIG. 7, the processing unit 130 may perform control for directing the solar panel 110 toward the point P. The position of P which is the point on the celestial sphere can be specified by the angle θ from the X axis and the angle φ from the Z axis. For this reason, with the use of (θ,φ), it is possible to uniquely specify a line segment OP connecting the origin O and the point P. In the processing unit 130, for example, an intersection point of the line segment OP and the movable area of the solar panel 110 may be determined as the position of the solar panel 110.

In the example described above referring to FIGS. 2 and 3, the solar panel 110 is movable on the columnar side surface. For this reason, an intersection point of the columnar side surface and the line segment OP may be set as a target position of the solar panel 110, and information representing the position may be used as the positional information.

In the processing unit 130, after the positional information is calculated, a specific control amount (the drive amount of the drive unit 121) for implementing the position of the solar panel 110 represented by the positional information is calculated. According to the example of FIG. 3, the processing unit 130 respectively calculates the drive amount of the first drive unit 1211 and the drive amount of the second drive unit 1212. Then, the processing unit 130 controls the drive unit 121 according to the calculated control amount, thereby implementing control for setting the solar panel 110 at a desired position.

As described above, the state of the obstacles change according to the season. Hence, in this embodiment, the obstacle information may be acquired by season. The above-described processing is performed using the obstacle information of each season and the orbit of the sun according to the season to determine the position of the solar panel 110 in each season. In a case of changing the position of the solar panel 110 once per week, for example, the acquisition of the obstacle information and the calculation of the positional information may be performed per week. It is difficult to consider that the state of the obstacles significantly change in a week. Hence, for example, a year may be divided into N periods (for example, in a case of taking four seasons into consideration, N=4), and N pieces of obstacle information may be acquired according to the respective periods. The processing unit 130 determines the position of the solar panel 110 in a given week based on the obstacle information corresponding to the target week among the N pieces of obstacle information and the orbit of the sun in the target week.

As described above, the processing unit 130 may perform control of the posture along with the control of the position of the solar panel 110. Various specific example of the posture in this case are considered. For example, the processing unit 130 controls the support 120 to take the posture in which the direction of the line segment OP of FIG. 7 matches the direction normal to the solar panel 110 (in a broader sense, the angle difference between the two directions is equal to or less than a given threshold value δ). While the control of the posture may be performed, for example, at the same frequency as the control of the position, a modification can be made in which the control frequency of the position and the control frequency of the posture are different.

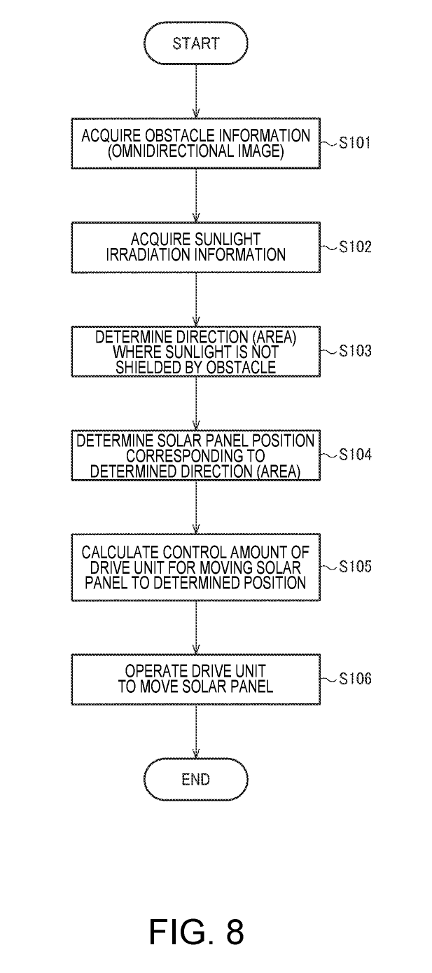

FIG. 8 is a flowchart illustrating the position control of the solar panel 110 according to this embodiment. If this processing is started, first, the processing unit 130 performs obstacle information acquisition processing (Step S101). In regard to this, as described above, the measurement system 100 may have a camera or image information acquired by other apparatuses may be acquired. The processing unit 130 acquires irradiation information of sunlight (Step S102). Specifically, the irradiation information is information representing the orbit of the sun in a target period. The processing unit 130 determines an area (irradiatable area) where sunlight is not shielded by the obstacles based on the obstacle information and the irradiation information (Step S103). The processing of S103 may be performed by projecting an omnidirectional camera image onto the celestial sphere as described above.

The processing unit 130 determines the position of the solar panel 110 corresponding to the irradiatable area based on the result in S103 (Step S104). This can be implemented with the processing described above referring to FIG. 7. The processing unit 130 calculates the control amount for implementing the position of the solar panel 110 determined in S104 (Step S105), and drives the drive unit 121 (actuator) according to the calculated control amount to move the solar panel 110 to a desired position (Step S106).

In FIG. 8, although the flowchart in which the processing of S101 to S105 and the processing of S106 are continuously performed has been shown, the invention is not limited thereto. For example, the processing of S101 to S105 may be performed in advance prior to the processing for actually moving the solar panel 110. For example, if a longitude and a latitude where the measurement system 100 is installed are determined, the irradiation information of sunlight becomes known. Hence, if the obstacle information is acquired, the position of the solar panel in each period can be calculated, and the calculation timing does not need to conform to the movement timing of the solar panel 110.

### 4. Modification Examples

Hereinafter, some modification examples will be described. The modification examples described below are not limited to the use of any one method, and a plurality of methods may be combined.

### 4.1 Use of Other Kinds of Natural Energy

The measurement system 100 according to this embodiment may include a power supply unit which supplies electric power based on natural energy different from sunlight. The processing unit 130 controls the position of the solar panel 110 based on electric power from the power supply unit.

Natural energy different from sunlight is, for example, wind power or hydroelectric power, and the power supply unit is a wind power generation unit or a hydroelectric power generation unit. The wind power generation unit is constituted of a propeller having a plurality of blades, a generator which operates with the rotation of the propeller, and the like. The hydroelectric power generation unit is constituted of a water turbine, a generator which operates with the rotation of the turbine, and the like. Various modifications can be made to the natural energy to be used or a specific configuration of the power supply unit which generates electric power from natural energy.

Electric power from the power supply unit may be electric power which is supplied directly from the power supply unit or electric power stored in a battery. The battery may be the same as or different from the battery 140 described above referring to FIG. 1.

With this, it is possible to divide electric power used for driving the sensor 150 as a sensor for monitoring and electric power used for driving the solar panel 110. That is, since a room is given in electric power usable for driving the solar panel 110, for example, it is possible to increase the drive frequency of the solar panel 110 or to implement flexible position change of the solar panel 110 while making the structure of the support 120 complicated.

It is expected that sunlight and other kinds of natural energy has a complementary relationship. For example, since sunlight intensity decreases in stormy weather, the amount of electric power generated by the solar panel 110 decreases. However, the wind speed increases or the amount of rainfall increases in stormy weather, and thus, there is a possibility that the amount of electric power generated by wind power or hydroelectric power increases. That is, with the use of natural energy in addition to sunlight, even in a situation in which power generation by sunlight cannot be expected, it is possible to continue the drive of the measurement system 100 for a long period. In this case, electric power from the power supply unit may be used for not only the position control of the solar panel 110 but also the operation of the sensor 150.

### 4.2 Modification Example of Configuration of Measurement System

In FIG. 2 or 4, although an example where one solar panel 110 is provided has been shown, the invention is not limited thereto. The measurement system 100 may include a plurality of solar panels as the solar panel 110, and the processing unit 130 may control the position of each solar panel of a plurality of solar panels.

With this, it is possible to more efficiently perform power generation using sunlight. Various specific examples of control are considered. For example, a plurality of solar panels are arranged at positions to be clearly different azimuths. With this, since there is an increasing possibility that any one solar panel among a plurality of solar panels can receive sunlight, it is not necessary to strictly control the position of each solar panel. That is, it is possible to reduce accuracy required for the position control.

Alternatively, a desired position of the solar panel 110 may be calculated by the method using FIGS. 6 and 7, and each solar panel may be arranged as close to the position as possible. For example, in a case where the desired position is (x_{d}, y_{d}, z_{d}) and the position of each solar panel is (xᵢ, yᵢ, zᵢ) (where i is an integer equal to or greater than 1 and equal to or less than M, and M is the number of solar panels), the position of each solar panel may be set such that an evaluation function E represented by Expression (3) described below is minimized.

$$E = {\sum }_{i = 1}^{M} {α}_{i} \sqrt{{( {x}_{d} - {x}_{i} )}^{2} + {( {y}_{d} - {y}_{i} )}^{2} + {( {z}_{d} - {z}_{i} )}^{2}} \qquad ( 3 )$$

The coefficient αᵢ in Expression (3) described above may be determined in consideration of the movable range of each solar panel determined by a specific structure of the support 120 or interference between the solar panels. The interference includes physical collision or a given solar panel shielding irradiation of other solar panels with sunlight. The evaluation function E may be a function different from Expression (3) described above. In determining the positions of a plurality of solar panels 110, a method different from the method using the evaluation function may be used.

### 4.3 Use of Other Kinds of Information

A method of controlling the position of the solar panel 110 based on the obstacle information or the irradiation information of sunlight has been described above. However, other kinds of information may be used in the position control of the solar panel 110.

For example, the processing unit 130 may control the position of the solar panel 110 based on weather information around the solar panel 110. The weather information is, for example, information relating to a wind direction and a wind speed or information relating to a snowfall. With this, it is possible to perform appropriate position control according to the weather state.

In a case of a strong wind, if the solar panel 110 is at a position (and in a posture) facing a direction in which the wind blows, the area of a surface receiving the wind increases, and large force is applied to the solar panel 110. With this, it is not preferable in that a possibility of a mechanical fault of the solar panel 110 or the support 120 increases. Hence, in this case, the processing unit 130 may move the solar panel 110 to a position in a direction different from (for example, a direction orthogonal to) the direction in which the wind blows.

In a case of a snowfall, if the solar panel 110 is in a posture to lie down (a posture in which the angle between the direction normal to the panel surface and the horizontal plane is large), snow lies on the solar panel 110, resulting in a fault of the solar panel 110 or the like as well. Hence, in this case, the processing unit 130 performs control for bringing the solar panel 110 into a posture to stand (a posture in which the angle between the direction normal to the panel surface and the horizontal plane is small).

### 4.4 Control Device, System, Program

Although it is assumed that the measurement system 100 according to this embodiment is an independent system without requiring electric power supply from the outside, the system does not need to be a stand-alone apparatus, and may perform transmission and reception of information with an external apparatus 200.

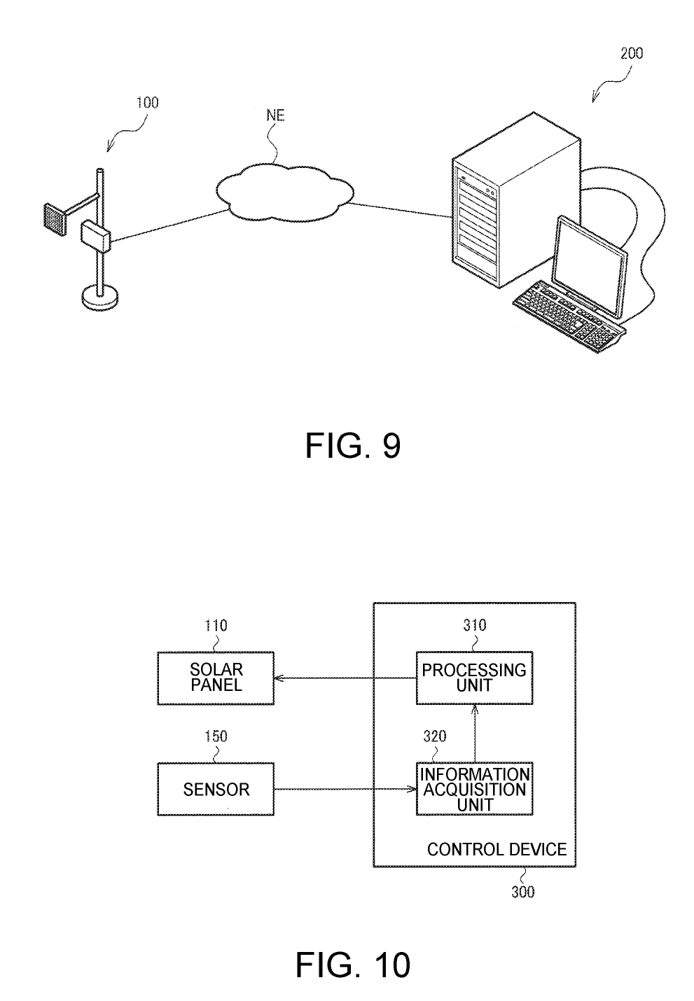

FIG. 9 shows a connection example of the measurement system 100 and the external apparatus 200. The measurement system 100 is connected to the external apparatus 200 through a network NE. The network NE can be implemented with a WAN, a LAN, a near field communication, or the like. The network NE may be a wired system or a wireless system, but it is desirable that the network NE is a wireless system taking into consideration the installation of the above-described cable or burden of maintenance. In FIG. 9, although a personal computer (PC) has been shown as the external apparatus 200, the external apparatus 200 may be other information processing apparatuses, such as a server system or a portable terminal apparatus (for example, a smartphone).

The measurement system 100 includes the communication unit 170 which receives information from the external apparatus 200, and the processing unit 130 performs various kinds of processing based on information received by the communication unit 170. For example, the communication unit 170 may receive the obstacle information from the external apparatus 200 as described above and may calculate the positional information based on the received obstacle information.

Alternatively, the processing unit 130 may control the position of the solar panel 110 based on information (in a narrow sense, positional information) relating to the position of the solar panel 110 set based on the obstacle information. Specifically, the communication unit 170 may receive the positional information, which is information capable of uniquely determining the position of the solar panel 110, from the external apparatus 200, and the processing unit 130 may control the position of the solar panel 110 based on the positional information received by the communication unit 170. As described above, if the obstacle information is acquired, since the irradiation information of sunlight is known information, it is possible to calculate the positional information. That is, the calculation of the positional information does not need to be executed in the measurement system 100, and may be performed in the external apparatus 200. In particular, there is a high possibility that the measurement system 100 according to this embodiment is constituted as an independent system, and there are greater restrictions on the processing performance of the processing unit 130 and the battery capacity compared to the external apparatus 200. If the calculation of the positional information is performed in the external apparatus 200, the processing unit 130 of the measurement system 100 may perform the control of the support 120 according to the positional information, whereby it is possible to reduce a processing load and power consumption in the measurement system 100.

As described above, the positional information may be information representing the position of the solar panel 110 or information representing the control amount of the drive unit 121 for implementing the position. In a case where the former is used, it is advantageous in that it is possible to use the format of the positional information calculated in the external apparatus 200 in common without depending on a specific configuration of the measurement system 100. In a case where the latter is used, since the processing (the processing corresponding to S105 of FIG. 7) for calculating a specific control amount in the measurement system 100 is not required, it is advantageous in that it is possible to further reduce a processing load in the measurement system 100.

The method of this embodiment is not limited as being applied to the measurement system 100 shown in FIG. 2 or 4. For example, the method of this embodiment can be applied to a control device 300 which performs control of the solar panel 110 or the sensor 150.

FIG. 10 shows a system configuration example of the control device 300. The control device 300 includes an information acquisition unit 320 which acquires the sensor information of the sensor 150 detecting the state of the structure based on electric power from the solar panel 110, and a processing unit 310 which performs processing based on the sensor information and the control of the position of the solar panel 110. The processing unit 310 sets the position of the solar panel 110 to the first position in the first predetermined period, and sets the position of the solar panel 110 to the second position different from the first position in the second predetermined period different from the first predetermined period.

The control device 300 can be implemented in various forms. For example, in the measurement system 100 described above referring to FIG. 2, the configuration included in the housing 10 may be considered as the control device 300. In this case, the processing unit 310 corresponds to the processing unit 130 described above. The information acquisition unit 320 is an interface, such as an analog-to-digital converter (A/D converter) which acquires information output from the sensor 150 (sensor housing 20) and an amplifier.

Alternatively, the control device 300 may be the external apparatus 200 shown in FIG. 9. In this case, the processing unit 130 of the measurement system 100 does not need to execute specific processing relating to the position control of the solar panel 110, and may perform control for moving the solar panel 110 according to control information transmitted from the external apparatus 200. The information acquisition unit 320 in this case is a reception processing unit (communication unit) which receives the sensor information through the network NE.

In a case where the external apparatus 200 is considered as the control device 300, the number of solar panels 110 or sensor units (sensors 150) connected to the control device 300 is not limited to one.

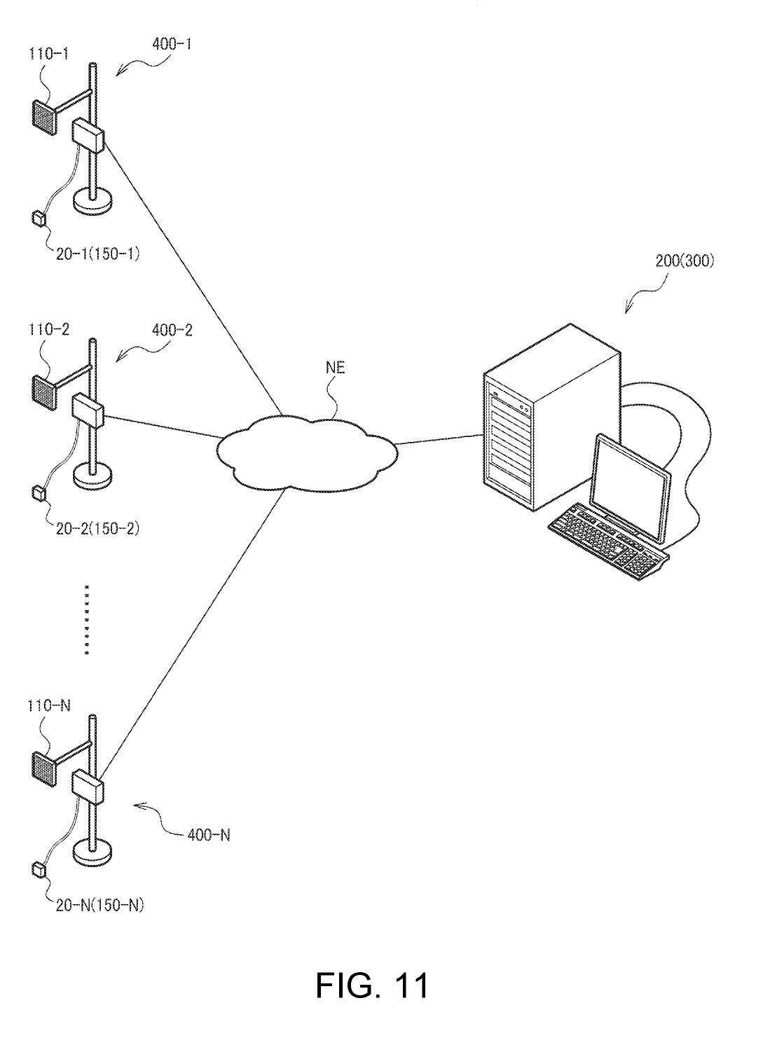

FIG. 11 shows a specific example of a system (monitoring system) in this case. The system of FIG. 11 includes one or a plurality of sensors 150, one or a plurality of solar panels 110 which supply electric power to the sensors 150, and the control device 300 which controls the position of each solar panel 110, and the control device 300 sets the position of each solar panel of one or a plurality of solar panels 110 to different positions in the first predetermined period and the second predetermined period different from the first predetermined period based on the positional information for determining the position of each solar panel 110.

In the example of FIG. 11, an example where the control device 300 is connected to N monitoring units 400-1 to 400-N through the network NE, and the respective monitoring units respectively include the solar panels 110 (110-1 to 110-N) and sensor housings 20 (20-1 to 20-N) including the sensors 150 (150-1 to 150-N). However, each monitoring unit can omit one of the solar panel 110 and the sensor 150. Specifically, the monitoring unit may be a unit (a unit for power generation only) which performs power generation with the solar panel 110, but does not perform a measurement with the sensor 150 or may be a unit (a unit for measurement only) which performs a measurement with the sensor 150, but does not perform power generation with the solar panel 110. In this case, electric power generated by a given unit can be supplied to other units.

Processing of a part of the measurement system 100 according to this embodiment or the processing of each unit of the control device 300 may be implemented with a program. That is, the method of this embodiment can be applied to a program which causes a computer to perform information acquisition processing for acquiring the sensor information from the sensor 150 detecting the state of the structure based on electric power from the solar panel 110, the processing based on the sensor information, and the position control of the solar panel 110. According to the program according to this embodiment, as the above-described position control, control for setting the position of the solar panel 110 to the first position in the first predetermined period and setting the position of the solar panel 110 to the second position different from the first position in the second predetermined period different from the first predetermined period is performed.

The measurement system 100 of this embodiment or the control device 300 includes a memory which stores information (for example, a program or various kinds of data), and a processor which operates based on information stored in the memory. The processor performs processing for controlling the position of the solar panel 110, and information acquisition processing for acquiring the sensor information of the sensor 150 operating based on electric power from the solar panel. The processor performs the position control for setting the position of the solar panel 110 to different positions in the first predetermined period and the second predetermined period different from the first predetermined period based on the positional information for determining the position of the solar panel 110.

The processor may implement the function of each unit with individual hardware or may implement the function of each unit with integrated hardware, for example. The processor may be, for example, a CPU. However, the processor is not limited to the CPU, and various processors, such as a graphics processing unit (GPU) and a digital signal processor (DSP), can be used. Furthermore, the processor may be a hardware circuit including an ASIC. The memory may be, for example, a semiconductor memory, such as a static random access memory (SRAM) or a dynamic random access memory (DRAM), may be a register, may be a magnetic storage device, such as a hard disk drive, or may be an optical storage device, such as an optical disk device. For example, the memory stores a computer-readable command, and the command is executed by the processor, whereby the function of each unit of an image processing apparatus is implemented. The command may be a command in a command set constituting a program or may be a command instructing a hardware circuit of a processor to operate.

The operation of this embodiment is implemented, for example, as follows. The processor acquires the positional information and stores the positional information in the memory. The processor may acquire the obstacle information and may perform the processing for calculating the positional information based on the obstacle information or may perform processing for receiving the positional information calculated by the external apparatus. The processor reads the positional information from the memory and performs control for moving the solar panel 110 to a position represented by the positional information. Specifically, processing is performed for outputting a control signal to the drive unit 121 of the support 120 (arm 122) in which the solar panel 110 is provided.

A part of the measurement system 100 of this embodiment or each unit of the control device 300 is implemented as a module of a program which operates on the processor. For example, the information acquisition unit 320 is implemented as an information acquisition module which acquires the sensor information from the sensor 150 operating based on electric power from the solar panel 110. The processing unit 310 is implemented as a processing module which performs the processing based on the sensor information and the position control of the solar panel.

The method of this embodiment can be applied to a method of controlling the measurement system 100 having the solar panel 110 capable of changing the position and the sensor 150 detecting the state of the obstacles based on electric power from the solar panel 110, the method including setting the position of the solar panel 110 to the first position in the first predetermined period, and setting the position of the solar panel 110 to the second position different from the first position in the second predetermined period different from the first predetermined period.

Although the embodiments to which the invention is applied and the modification examples thereof have been described above, the invention is not limited to the respective embodiments or the modification examples thereof, and can be embodied in an implementation phase by modifying the constituent elements without departing from the spirit or scope of the invention. A plurality of constituent elements disclosed in the respective embodiments or the modification examples described above can be appropriately combined to form various inventions. For example, some constituent elements may be deleted from all constituent elements described in the respective embodiments or the modification examples. Furthermore, the constituent elements described in different embodiments or modification examples may be appropriately combined. In addition, in the specification and drawings, the terms described at once with different terms with broader or the same meaning can be replaced with terms different from those in any place of the specification and drawings. In this way, various modifications or applications can be made without departing from the spirit or scope of the invention.

The entire disclosure of Japanese Patent Application No. 2016-065221 filed Mar. 29, 2016 is expressly incorporated by reference herein.

What is claimed is:

1. A measurement system comprising:
a solar panel;
a support which supports a position of the solar panel in a changeable manner;
a battery which stores electric power from the solar panel;
a sensor which detects a state of a structure based on electric power from the solar panel; and
a processing unit which performs processing based on sensor information from the sensor,
wherein the position of the solar panel supported by the support is different in a first predetermined period and a second predetermined period different from the first predetermined period.

2. The measurement system according to claim 1,
wherein, in the first predetermined period, the processing unit sets the position of the solar panel to a first position, and
in the second predetermined period, the processing unit sets the position of the solar panel to a second position different from the first position.

3. The measurement system according to claim 1,
wherein the position of the solar panel is a position set based on obstacle information around the solar panel.

4. The measurement system according to claim 3,
wherein the obstacle information is information representing a state of trees around the solar panel.

5. The measurement system according to claim 3,
wherein the processing unit controls the position of the solar panel based on information relating to the position of the solar panel set based on the obstacle information or information relating to the position of the solar panel determined based on the obstacle information.

6. The measurement system according to claim 1, further comprising:
a storage unit which stores positional information as information capable of uniquely determining the position of the solar panel,
wherein the processing unit controls the position of the solar panel based on the positional information from the storage unit.

7. The measurement system according to claim 1, further comprising:
a communication unit which receives positional information as information capable of uniquely determining the position of the solar panel from an external apparatus,
wherein the processing unit controls the position of the solar panel based on the positional information received by the communication unit.

8. The measurement system according to claim 1,
wherein the support supports at least one of a position in a vertical direction or a position in a horizontal direction of the solar panel in a changeable manner.

9. The measurement system according to claim 8,
wherein the support includes an arm to which the solar panel is fixed, and
the processing unit drives the arm to change at least one of the position in the vertical direction or the position in the horizontal direction of the solar panel.

10. The measurement system according to claim 9,
wherein the support includes a guide shaft in which a direction along the vertical direction is a longitudinal direction, and
the arm is configured to perform at least one of movement in the longitudinal direction of the guide shaft or rotation around the guide shaft.

11. The measurement system according to claim 1, further comprising:
a power supply unit which supplies electric power based on natural energy different from sunlight,
wherein the processing unit controls the position of the solar panel based on electric power from the power supply unit.

12. The measurement system according to claim 1, further comprising:
a plurality of solar panels as the solar panel,
wherein the processing unit controls the position of the plurality of solar panels.

13. The measurement system according to claim 1,
wherein the first predetermined period and the second predetermined period are specific periods of a year.

14. The measurement system according to claim 1,
wherein the processing unit controls the position of the solar panel based on weather information around the solar panel.

15. The measurement system according to claim 1,
wherein the support supports a posture of the solar panel in a changeable manner, and
the processing unit controls the position and the posture of the solar panel.

16. A control device comprising:
an information acquisition unit which acquires sensor information from a sensor detecting a state of a structure based on electric power from a solar panel; and
a processing unit which performs processing based on the sensor information and control of a position of the solar panel,
wherein, in a first predetermined period, the processing unit sets the position of the solar panel to a first position, and
in a second predetermined period different from the first predetermined period, the processing unit sets the position of the solar panel to a second position different from the first position.

17. A method of controlling a measurement system having a solar panel capable of changing a position and a sensor detecting a state of a structure based on electric power from the solar panel, the method comprising:
in a first predetermined period, setting the position of the solar panel to a first position; and
in a second predetermined period different from the first predetermined period, setting the position of the solar panel to a second position different from the first position.

18. A program which causes a computer to execute:
information acquisition processing for acquiring sensor information from a sensor detecting a state of a structure based on electric power from a solar panel;
processing based on the sensor information; and
position control of a solar panel,
wherein, as the position control,
in a first predetermined period, the position of the solar panel is set to a first position, and
in a second predetermined period different from the first predetermined period, the position of the solar panel is set to a second position different from the first position.
